(19) United States
(12) Patent Application Publication
(10) Pub. No.: US 2010/0309166 A1
(43) Pub. Date: Dec. 9, 2010

(54) TOUCH PANEL AND DISPLAY DEVICE EQUIPPED WITH THE SAME

(75) Inventor: Minoru Mayumi, Osaka (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka-shi, Osaka (JP)

(21) Appl. No.: 12/811,147

(22) PCT Filed: Jan. 30, 2009
(86) PCT No.: PCT/JP2009/000364

§ 371 Date: Jun. 29, 2010

(30) Foreign Application Priority Data
Apr. 10, 2008 (JP) 2008-102317

(51) Int. Cl. G06F 3/045

(52) U.S. Cl. 345/174

(57) ABSTRACT

A capacitive touch panel (30) includes a touch electrode (11) provided on an insulating substrate (10), and a coordinate correction pattern (16a) provided in a frame form so as to be along the periphery of the touch electrode (11) and connected to the periphery of the touch electrode (11). The touch panel (30) detects a touch position in the touch electrode (11) based on an electrical signal through a coordinate correction pattern (16a). The coordinate correction pattern (16a) is provided in a flexible printed circuit (20) bonded to the insulating substrate (10).

### TECHNICAL FIELD

The present invention relates to a touch panel and a display device equipped therewith, and particularly relates to a capacitive touch panel and a display device equipped therewith.

### BACKGROUND ART

Touch panels are classified according to operating principle into a resistive type, a capacitive type, an infrared type, an ultrasonic type, an electromagnetic induction type and other types.

Described in, for example, PATENT DOCUMENT 1 is a configuration in which a projection portion is provided on a second transparent substrate included in a resistive-type touch panel, and a flexible printed circuit (FPC) is bonded to the projection portion by thermocompression, which makes it possible to form a narrow width of a frame excluding the projection portion serving as a portion in which the FPC is arranged.

### Citation List

### Patent Document

PATENT DOCUMENT 1: Japanese Patent Publication No. 2005-158008

### SUMMARY OF THE INVENTION

### Technical Problem

A capacitive touch panel includes, for example, a transparent touch electrode provided on an insulating substrate and four lead-out lines provided so as to connect their respective four corners of the touch electrode with a position detecting circuit placed outside. The capacitive touch panel is configured such that the position detecting circuit detects the position of touching on the basis of a change in current in each lead-out line which occurs by the fact that the touch electrode is grounded through the electrostatic capacity of a human body at a position where the touch electrode is touched.

In the capacitive touch panel, a large deviation between a position of touching in a peripheral portion of the touch electrode and coordinates detected by the position detecting circuit easily occurs. Therefore, a coordinate correction pattern in a frame form is provided along the periphery of the touch electrode to correct the coordinates so that the position of the touching and the detected coordinates become closer.

In a capacitive touch panel to be mounted on a display screen of a display device, a display area in which an image is displayed inside a coordinate correction pattern and a frame area in which the coordinate correction pattern is disposed around the display area and which does not directly contribute to displaying an image are defined, and making the frame area as small as possible relative to the display area is demanded. Here, a mask needs to be disposed on an insulating substrate in order to form the coordinate correction pattern along the periphery of a touch electrode by deposition of a conductive film and patterning of the conductive film by means of photolithography, or printing a conductive paste. As a result, a large non-film deposition (printing) area, or the frame area, having a width equal to or larger than a certain value is designed in the peripheral portion of the insulating substrate.

In view of such an issue, the present invention has been made. An object of the invention is to make the frame area as small as possible.

### Solution to the Problem

To achieve the object, the invention provides a coordinate correction pattern in a flexible printed circuit bonded to an insulating substrate on which a touch electrode is provided.

Specifically, a touch panel according to the invention is a capacitive touch panel which includes a touch electrode provided on an insulating substrate, and a coordinate correction pattern provided in a frame form so as to be along the periphery of the touch electrode and connected to the periphery of the touch electrode, and which detects a touch position in the touch electrode based on an electrical signal through the coordinate correction pattern, wherein the coordinate correction pattern is provided in a flexible printed circuit bonded to the insulating substrate.

According to the above configuration, the flexible printed circuit, which is different from the insulating substrate with the touch electrode thereon, is provided with the coordinate correction pattern connected to the touch electrode. Therefore, the flexible printed circuit with the coordinate correction pattern therein is disposed so as to overlap a peripheral portion of a film formation area of the insulating substrate, on which the touch electrode is provided up to a substrate peripheral portion, so that the touch panel including the coordinate correction pattern is formed. This makes it possible to design a frame area of an insulating substrate having a narrower width than that in cases where a touch electrode and a coordinate correction pattern are provided on the same insulating substrate like a conventional case. Accordingly, it becomes possible to make the frame area as small as possible in the touch panel.

To form a coordinate correction pattern, an insulating substrate with a touch electrode thereon has conventionally been subjected to a patterning process of patterning by means of photolithography, a printing process of printing a conductive paste, or the like. However, according to the above configuration, forming a touch panel having the coordinate correction pattern becomes possible only by bonding, to the insulating substrate with the touch electrode thereon, a flexible printed circuit in which the coordinate correction pattern has been formed in advance, by means of compression bonding or the like. The patterning process or the printing process mentioned above becomes unnecessary. This makes it possible to suppress manufacturing costs.

A plurality of lead-out lines connected to the coordinate correction pattern may be provided in the flexible printed circuit.

According to the above configuration, in which the plurality of lead-out lines are connected to the coordinate correction pattern in the flexible printed circuit, an electrical signal through the coordinate correction pattern which is generated by touching the touch electrode is specifically output through each lead-out line to an outside position detecting circuit. Also, the flexible printed circuit, which is different from the insulating substrate with the touch electrode thereon, is provided with the coordinate correction pattern connected to the touch electrode and the plurality of lead-out lines connected to the coordinate correction pattern. Therefore, the flexible printed circuit with the coordinate correction pattern and the plurality of lead-out lines therein is disposed so as to overlap the peripheral portion of the film formation area of the insulating substrate, on which the touch electrode is provided up to the substrate peripheral portion, so that the touch panel including the coordinate correction pattern and the plurality of lead-out lines is formed. This makes it possible to design a frame area of an insulating substrate having a narrower width than that in cases where a touch electrode, a coordinate correction pattern and a plurality of lead-out lines are provided on the same insulating substrate like a conventional case.

Each of the lead-out lines may be provided so as to overlap the coordinate correction pattern with an insulator interposed therebetween.

According to the above configuration, in which each lead-out line is disposed so as to overlap the coordinate correction pattern with the insulator interposed therebetween, it becomes possible for the frame area to be made smaller than that in cases where each lead-out line is not disposed so as to overlap the coordinate correction pattern.

The flexible printed circuit may be configured to output an electrical signal through the coordinate correction pattern and each of the lead-out lines to the outside.

According to the above configuration, in which the flexible printed circuit is configured to output the electrical signal through the coordinate correction pattern and each of the lead-out lines to the outside, it becomes possible for the flexible printed circuit with the coordinate correction pattern therein to be used also as the flexible printed circuit for outputting an electrical signal through each lead-out line to the outside (e.g., an external position detecting circuit).

A shielding pattern for shielding electrical noise from outside may be provided in the flexible printed circuit.

According to the above configuration, in which the shielding pattern is provided in the flexible printed circuit, a shielding pattern need not be separately formed in the insulating substrate on which the touch electrode 11 is provided.

A display device according to the invention is a capacitive touch panel, and a display panel disposed to face the touch panel. The touch panel includes a touch electrode provided on an insulating substrate, and a coordinate correction pattern provided in a frame form so as to be along a periphery of the touch electrode and connected to the periphery of the touch electrode. The touch panel is configured to detect a touch position in the touch electrode based on an electrical signal through the coordinate correction pattern. The coordinate correction pattern is provided in a flexible printed circuit bonded to the insulating substrate.

According to the above configuration, the flexible printed circuit, which is different from the insulating substrate with the touch electrode thereon, is provided with the coordinate correction pattern connected to the touch electrode. Therefore, the flexible printed circuit with the coordinate correction pattern therein is disposed so as to overlap a peripheral portion of a film formation area of the insulating substrate, on which the touch electrode is provided up to a substrate peripheral portion, so that the touch panel including the coordinate correction pattern is formed. This makes it possible to design a frame area of an insulating substrate having a narrower width than that in cases where a touch electrode and a coordinate correction pattern are provided on the same insulating substrate like a conventional case. Accordingly, it becomes possible to make the frame area as small as possible in a display device including a touch panel.

To form a coordinate correction pattern, an insulating substrate with a touch electrode thereon has conventionally been subjected to a patterning process of patterning by means of photolithography, a printing process of printing a conductive paste, or the like. However, according to the above configuration, forming a touch panel including the coordinate correction pattern becomes possible only by bonding, to the insulating substrate with the touch electrode thereon, a flexible printed circuit in which the coordinate correction pattern has been formed in advance, by means of compression bonding or the like. The patterning process or the printing process mentioned above becomes unnecessary. This makes it possible to suppress manufacturing costs.

### Advantages of the Invention

According to the invention, a coordinate correction pattern is provided in a flexible printed circuit bonded to an insulating substrate provided with a touch electrode, which enables a frame area to be made as small as possible.

### BRIEF DESCRIPTION OF THE DRAWINGS

FIG. 1 is a plan view of a touch panel 30 according to Embodiment 1.

FIG. 2 is a cross-sectional view of a liquid crystal display device 50 including that of the touch panel 30 taken along the line II-II in FIG. 1.

FIG. 3 is a plan view illustrating a coordinate correction pattern 16b included in a touch panel according to Embodiment 2.

### DESCRIPTION OF EMBODIMENTS

Embodiments of the invention will be described in detail below. Note that the invention is not limited to the following embodiments.

### First Embodiment of the Invention

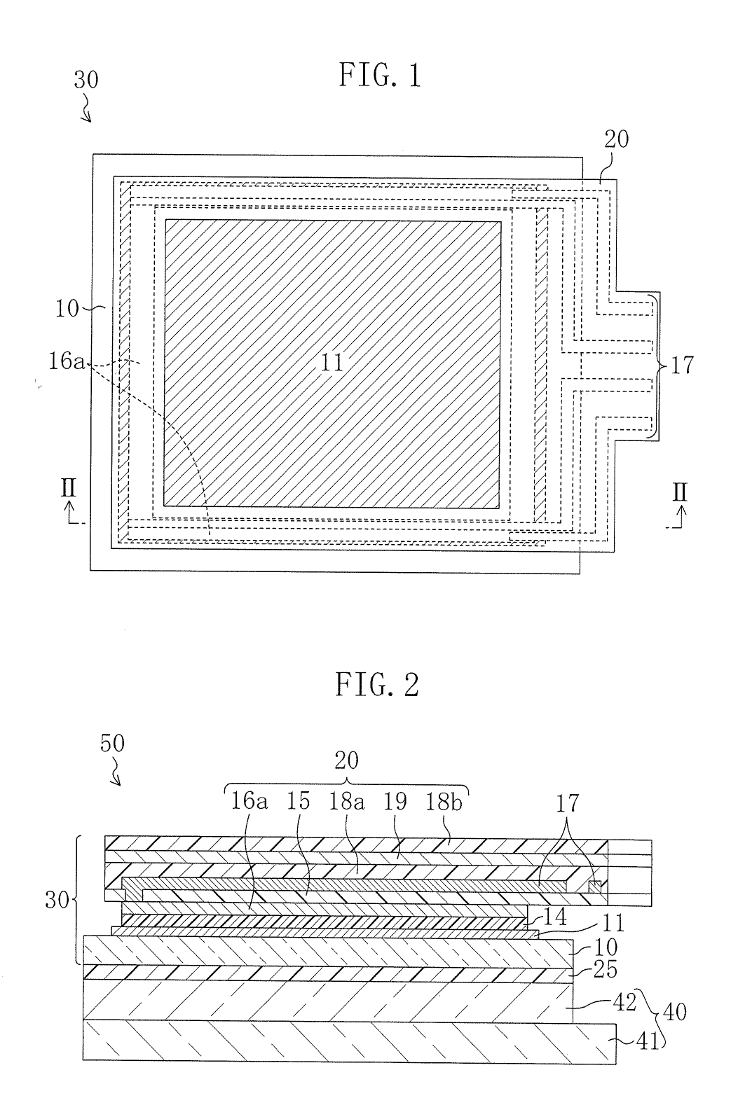

FIG. 1 and FIG. 2 illustrate Embodiment 1 of a touch panel and a display device equipped therewith according to the invention. Specifically, FIG. 1 is a plan view of the touch panel 30 of the present embodiment. FIG. 2 is a cross-sectional view of the liquid crystal display device 50 including that of the touch panel 30 taken along the line II-II of FIG. 1.

The liquid crystal display device 50, as illustrated in FIG. 2, includes the capacitive touch panel 30, and a liquid crystal display panel 40 disposed to face the touch panel 30. Here, the touch panel 30 and the liquid crystal display panel 40 are bonded to each other by using a bonding layer 25.

The touch panel 30, as illustrated in FIG. 1 and FIG. 2, includes an insulating substrate 10, such as a glass substrate, having a touch electrode 11, and a flexible printed circuit (hereinafter referred to as an “FPC”) 20 provided in a frame form such that it extends along the periphery of the insulating substrate 10. Here, the insulating substrate 10 and the FPC 20 are bonded to each other with an anisotropic conductive film (hereinafter referred to as an “ACF”) 14 interposed therebetween.

The touch electrode 11, as illustrated in FIG. 1, is provided in a rectangular form of a transparent conductive film made of, for example, ITO (indium tin oxide) or the like, and is covered with a protective film (not shown) of, for example, an inorganic insulating film, such as a silicon nitride film, or an organic insulating film, such as acrylic resin.

The FPC 20, as illustrated in FIG. 1 and FIG. 2, includes a base film 15 provided as an insulator of, for example, a polyimide film or the like, a coordinate correction pattern 16a provided in a frame form on the bottom surface the base film 15, four lead-out lines 17 provided on the top surface of the base film 15 such that one ends of the lead-out lines 17 overlap the respective corners of the coordinate correction pattern 16a, the other ends extend to a central portion (outputting portion) of one end (right end of FIG. 1) of the base film 15, a first cover lay 18a provided on the top surface of the base film 15 so as to cover each lead-out line 17, a shielding pattern 19 provided on the top surface of the first cover lay 18a, and a second cover lay 18b provided so as to cover the shielding pattern 19.

The coordinate correction pattern 16a and each lead-out line 17 are formed of conductive metal films or metal foils of copper or the like, and are connected to each other with a contact hole in the base film 15.

The first cover lay 18a and the second cover lay 18b are formed of, for example, a polyimide film with an adhesive applied thereto.

The shielding pattern 19 is configured to block electrical noise from the outside, for example, by using a conductive metal film or a metal foil of copper or the like.

Here, as illustrated in FIG. 2, the coordinate correction pattern 16a of the bottom surface of the FPC 20 is provided along the periphery of the touch electrode 11 on the top surface of the insulating substrate 10, and is connected to the periphery of the touch electrode 11 with the ACF 14 interposed therebetween.

Note that, in the touch panel 30, a display area for performing image display of the liquid crystal display panel 40 is defined inside the FPC 20 in which the coordinate correction pattern 16a is provided, and a frame area is defined around the display area.

The liquid crystal display panel 40, as illustrated in FIG. 2, includes, for example, an active matrix substrate 41 and a counter substrate 42 disposed to face each other, and a liquid crystal layer (not shown) provided between the active matrix substrate 41 and the counter substrate 42. Note that polarizing plates (not shown) are attached to the top surface and the bottom surface of the liquid crystal display panel 40.

The active matrix substrate 41 includes, for example, a plurality of gate lines (not shown) extending in parallel to one another on the insulating substrate, such as a glass substrate, a plurality of source lines (not shown) extending in parallel to one another in directions perpendicular to the gate lines, a plurality of TFTs (not shown) provided per each of intersection portions of the gate lines and the source lines, an interlayer insulating layer (not shown) covering all the TFTs, a plurality of pixel electrodes (not shown) provided in a matrix form on the interlayer insulating layer and connected to the respective TFTs, and an alignment layer (not shown) covering all the pixel electrodes. Here, each of the pixel electrodes forms a pixel, or a minimum unit of an image, and the pixel electrodes are aligned in a matrix form, so that the whole of them forms a display area for displaying an image.

The counter substrate 42 includes, for example, a color filter layer (not shown) having a red layer (R), a green layer (G) and a blue layer (B) provided on the insulating substrate, such as a glass substrate, a common electrode (not shown) covering the color filter layer, and an alignment layer (not shown) covering the common electrode.

The liquid crystal display device 50 in the configuration described above is configured such that a given voltage is applied to the liquid crystal layer between the active matrix substrate 41 and the counter substrate 42 to adjust the transmittance of light which passes through the liquid crystal display panel 40, so that an image is displayed through the touch panel 30, and such that touching the surface of the touch electrode 11 causes the touch electrode 11 to be grounded through the electrostatic capacity of a human body at the position of the touching, thereby resulting in a change in resistance between four corners of the coordinate correction pattern 16a and the position of the touching, so that a position detecting circuit (not shown) connected to each of the lead-out lines 17 detects the position of the touching on the basis of the change in resistance.

As described above, according the touch panel 30 and the liquid crystal display device 50 equipped therewith of the embodiment, the FPC 20, which is different from the insulating substrate 10 with the touch electrode 11 thereon, is provided with the coordinate correction pattern 16a connected to the touch electrode 11 and four lead-out lines 17. The FPC 20, in which the coordinate correction pattern 16a and the lead-out lines 17 are provided, is disposed so as to overlap a peripheral portion of a film formation area of the insulating substrate 10, on which the touch electrode 11 is provided up to a substrate peripheral portion, so that the touch panel 30 including the coordinate correction pattern 16a and the lead-out lines 17 is formed. This makes it possible to design a frame area of an insulating substrate having a narrower width than that in cases where a touch electrode, a coordinate correction pattern and lead-out lines are provided on the same insulating substrate like a conventional case. Accordingly, the frame area can be made as small as possible in the touch panel 30 and in the liquid crystal display device 50 with it.

To form the coordinate correction pattern 16a and the lead-out lines 17, an insulating substrate with a touch electrode thereon has conventionally been subjected to a patterning process of patterning by means of photolithography, a printing process of printing a conductive paste, or the like. However, according to the touch panel 30 and the liquid crystal display device 50 equipped therewith of the embodiment, only bonding the FPC 20, in which the coordinate correction pattern 16a and the lead-out lines 17 have been formed in advance, to the insulating substrate 10 with the touch electrode 11 thereon enables the touch panel 30 including the coordinate correction pattern 16a and the lead-out lines 17 to be formed. The patterning process or the printing process mentioned above becomes unnecessary, which enables manufacturing costs to be suppressed.

According to the touch panel 30 and the liquid crystal display device 50 equipped therewith of the embodiment, each lead-out line 17 is disposed so as to overlap the coordinate correction pattern 16a with the base film 15 interposed therebetween, which enables the frame area to be made smaller than that in cases where each lead-out line is not disposed so as to overlap the coordinate correction pattern.

According to the touch panel 30 and the liquid crystal display device 50 equipped therewith of the embodiment, the FPC 20 is configured to output an electrical signal through the coordinate correction pattern 16a and each lead-out line 17 to the outside. This enables the FPC (20) provided with the coordinate correction pattern 16a to be used also as the FPC (20) for outputting an electrical signal through each lead-out line 17 to an external position detecting circuit.

According to the touch panel 30 and the liquid crystal display device 50 equipped therewith of the embodiment, the shielding pattern 19 is provided in the FPC 20, and therefore a shielding pattern need not be separately formed on the insulating substrate 10 on which the touch electrode 11 is provided.

Note that in the touch panel 30 of the embodiment, four lead-out lines 17 are connected to the coordinate correction pattern 16a, and a touch position on a surface extending two-dimensionally is detected by measuring a current flowing in each lead-out line 17; however, the number of lead-out lines 17 connected to the coordinate correction pattern 16a is not limited to four. Here, the minimum number of lead-out lines necessary for detecting a two-dimensional position is three. However, the number of lead-out lines may be increased to five or more to improve the accuracy of position detection.

### Second Embodiment of the Invention

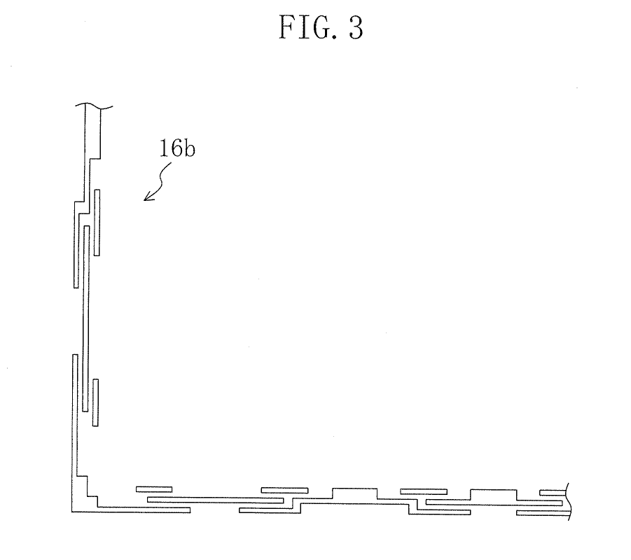

FIG. 3 is a plan view illustrating a coordinate correction pattern 16b included in a touch panel of the present embodiment.

In the touch panel 30 of the above Embodiment 1, each linear portion of the coordinate correction pattern 16a is formed with the same width along its extending direction as illustrated in FIG. 1. However, in a touch panel of the embodiment, each linear portion of the coordinate correction pattern 16b is formed such that a plurality of linear patterns in the form of islands spaced from one another are regularly arranged as illustrated in FIG. 3.

According to a touch panel of the embodiment, like the above Embodiment 1, the coordinate correction pattern 16b (and four lead-out lines 17) connected to the touch electrode 11 is provided in the FPC 20 which is different from the insulating substrate 10 with the touch electrode 11 provided thereon. This enables a frame area to be made as small as possible.

While a liquid crystal display device has been described as a display device in the above embodiments, the present invention is also applicable to other display devices, such as organic EL (electro luminescence) display devices and plasma display devices.

### INDUSTRIAL APPLICABILITY

As described above, the present invention enables a frame area to be made smaller and therefore is useful for display devices for mobile applications.

### DESCRIPTION OF REFERENCE CHARACTERS

10 Insulating Substrate

11 Touch Electrode

15 Base Film (Insulator)

16a, 16b Coordinate Correction Pattern

17 Lead-Out Line

19 Shielding Pattern

20 FPC (Flexible Printed Circuit)

30 Touch Panel

40 Liquid Crystal Display Panel

50 Liquid Crystal Display Device

1. A capacitive touch panel, comprising:
a touch electrode provided on an insulating substrate; and
a coordinate correction pattern provided in a frame form so as to be along a periphery of the touch electrode and connected to the periphery of the touch electrode,
the touch panel detecting a touch position in the touch electrode based on an electrical signal through the coordinate correction pattern,
wherein
the coordinate correction pattern is provided in a flexible printed circuit bonded to the insulating substrate.

2. The touch panel according to claim 1, wherein
a plurality of lead-out lines connected to the coordinate correction pattern are provided in the flexible printed circuit.

3. The touch panel according to claim 2, wherein
each of the lead-out lines is provided so as to overlap the coordinate correction pattern with an insulator interposed therebetween.

4. The touch panel according to claim 2, wherein
the flexible printed circuit is configured to output an electrical signal through the coordinate correction pattern and each of the lead-out lines to outside.

5. The touch panel according to claim 1, wherein
a shielding pattern for shielding electrical noise from outside is provided in the flexible printed circuit.

6. A display device comprising:
a capacitive touch panel; and
a display panel disposed to face the touch panel,
wherein
the touch panel comprises a touch electrode provided on an insulating substrate, and a coordinate correction pattern provided in a frame form so as to be along a periphery of the touch electrode and connected to the periphery of the touch electrode, the touch panel being configured to detect a touch position in the touch electrode based on an electrical signal through the coordinate correction pattern, and
the coordinate correction pattern is provided in a flexible printed circuit bonded to the insulating substrate.
